(19) United States
(12) Patent Application Publication
(10) Pub. No.: US 2002/0125997 A1
(43) Pub. Date: Sep. 12, 2002

(54) Printed circuit with ID tag and method for recognizing of distribution root

(76) Inventors: Motofumi Kashi, Tokyo (JP); Yasushi Hattori, Tokyo (JP)

Correspondence Address: TRASK BRITT, P.O. BOX 2550, SALT LAKE CITY, UT, 84110, US

(21) Appl. No.: 09/748,054

(22) Filed: Dec. 22, 2000

(51) Int. Cl. H04Q 5/22; G08B 13/14

(52) U.S. Cl. 340/10.52; 340/572.8

(57) ABSTRACT

There is provided a printed circuit with an ID tag capable of maintaining secrecy of an ID code attached to the printed circuit and capable of recognizing a route of delivery from data of the ID code of the printed circuit and generally controlling history (including information of kind and fabrication source of semiconductor chip) of the printed circuit and a mounted electronic part including the route of the distribution after fabrication. The printed circuit is constructed by a constitution in which a noncontact ID tag having a fixed ID portion exclusive for reading storing the ID code specifying at least the printed circuit and a variable ID portion comprising a plurality of memory cells capable of changing the ID code by instruction from outside, is embedded in an inner layer portion of the printed circuit.

### BACKGROUND OF THE INVENTION

1. Technical Field

The present invention relates to a printed circuit with an ID tag having a noncontact ID tag and a method of recognizing a distribution route of a printed circuit, particularly to a printed circuit with an ID tag and a method of recognizing a distribution route of a printed circuit capable of generally controlling the printed circuit and a history (including information of kind and fabrication source of semiconductor chip) of a mounted electronic part including a distribution route after fabrication based on an ID code attached to the printed circuit.

2. Description of the Related Art

Conventionally, as a method of controlling a history such as a fabrication condition in mounting an electronic part on a printed circuit, for example, there is adopted a method in which after mounting an electronic part onto a printed circuit, ID for specifying the circuit is attached onto the printed circuit by printing or etching and a fabrication register in correspondence with the ID is formed to thereby control the fabrication history. Further, there is widely adopted also a method in which a bar code is used as a storage medium for storing an ID code, the bar code is pasted on a printed circuit and information of the bar code is read by a bar code reading apparatus to thereby control the fabrication history. Further, in recent years, there is adopted also a method in which a mark representing ID information including additional information such as fabrication factory or fabrication year and month, is directly marked on a printed circuit by laser beam and the ID information represented by the mark is read by a mark reading apparatus to thereby control the fabrication history.

As described above, according to the method of controlling the fabrication history by attaching ID to a printed circuit, the fabrication history has been controlled by attaching ID directly on a printed circuit by etching or direct marking in a fabrication stage or pasting a bar code and using ID thereof. However, according to the method, although the fabrication history of the printed circuit or a mounted electronic part can be investigated by looking at a control register in correspondence with ID attached to a printed circuit, thereafter, it has not been possible to recognize and control the route of distribution, that is, when and how the printed circuit is distributed and is made on sale.

Further, according to the above-described system of providing the ID code of the related art, the ID code is optically recognizably attached to a surface portion of the printed circuit and therefore, there has been a problem that the ID code is devoid of secrecy. Further, there has also been a problem that a portion of the ID code is polished by a grinder or the like such that the ID code cannot be recognized or a forged article is attached with forged ID code and is made on sale.

### SUMMARY OF THE INVENTION

The invention has been made in view of the above-described situation and it is an object of the invention to provide a printed circuit with an ID tag and a method of recognizing a distribution route of a printed circuit capable of holding secrecy of an ID code attached to the printed circuit and capable of recognizing delivery route from data of the ID code of the printed circuit and generally controlling history (including information of kind and fabrication source of semiconductor chip) of the printed circuit and a mounted electronic part including distribution route after fabrication.

The invention relates to a printed circuit with an ID tag having a noncontact ID chip and a method of recognizing a distribution route of a printed circuit and the above-described object of the invention is achieved by a printed circuit with an ID tag, wherein a noncontact ID tag having a fixed ID portion exclusive for reading storing an ID code at least specifying the printed circuit and a variable ID portion comprising a plurality of memory cells capable of changing the ID code by an instruction from outside, is embedded to an inner layer portion of the printed circuit.

Further, the object is achieved further effectively respectively by the constitution that a chip for ID of the noncontact ID tag comprises a transponder element, the respective memory cells of the variable ID portion are arranged in one row or in a matrix and recorded with ID codes at least indicating a route of distribution of the printed circuit by the instruction from the outside, the ID code recorded in the variable ID portion includes identifying information for specifying a kind of business dealing with the printed circuit and the ID code recorded in the variable ID portion includes identifying information of a kind and a fabrication source of an electronic part mounted to the printed circuit.

Further, according to method invention, the object is achieved by a method of recognizing a distribution route, the method comprising the steps of embedding a tag for noncontact ID having a fixed ID portion exclusive for reading storing an ID code specifying at least the printed circuit and a variable ID portion comprising a plurality of memory cells capable of changing the ID code by an instruction from outside, at an inner layer portion of the printed circuit in a stage of fabricating the printed circuit, writing the ID code specifying at least the printed circuit at the fixed ID portion, recording the ID code indicating a route of distribution at the variable ID portion by the instruction from the outside at least at a delivery stage thereof, and recognizing the route of the distribution of the printed circuit based on data of the respective ID codes of the fixed ID portion and the variable ID portion.

### BRIEF DESCRIPTION OF THE DRAWINGS

FIG. 1 is a sectional view showing an example of a constitution of a printed circuit with an ID tag according to the invention;

FIGS. 2A and 2B are views showing an example of a structure of a noncontact ID tag used in the invention;

FIGS. 3A and 3B are views showing other example of a structure of a noncontact ID tag used in the invention;

FIG. 4 is a schematic diagram showing a constitution of a memory for ID information according to the invention; and

FIG. 5 is a schematic diagram showing an example of ID information stored to the memory for ID information according to the invention.

### DESCRIPTION OF PREFERRED EMBODIMENTS

A detailed explanation will be given of preferred embodiments according to the invention in reference to the drawings as follows.

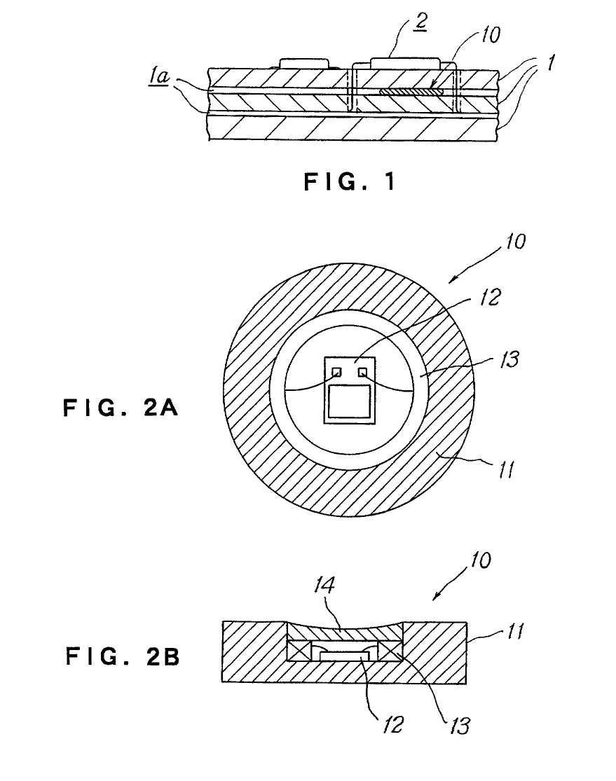

FIG. 1 shows, by a sectional view, an example of a constitution of a printed circuit with an ID tag according to the invention and at an inner layer portion of a printed circuit 1 mounted with various electronic parts 2, there is embedded a noncontact ID tag 10 for transmitting and receiving data to and from outside in wireless. The printed circuit 1 to which the invention is applied, is of a general multiple layer structure having two layers or more and the noncontact ID tag 10 constituting the object of embedding, is embedded in an adhesive layer 1a between the printed circuits in steps of laminating and adhering contiguous ones of the printed circuits 1 via a roller.

Although as a chip for ID, there may be used an RFID element (in this case, referred to an RFID tag using radio wave in an LF band through a UHF band) mainly used in a noncontact type tag system (“RFID (Radio Frequency Identification) SYSTEM”), it is preferable to use a transponder element capable of carrying out transmission at a long distance using radio wave at high frequency (band of microwave).

The noncontact ID tag 10 contains an antenna built therein serving for both of power reception and data reception/transmission, receives instruction/data from outside transmitted by being superposed on a carrier wave, generates necessary power by the carrier wave and transmits information to outside (host computer) by utilizing the power in writing/reading and transmitting data. According to the invention, a storage for ID information of the transponder element is constituted by a plurality of storage elements and various ID codes can be stored.

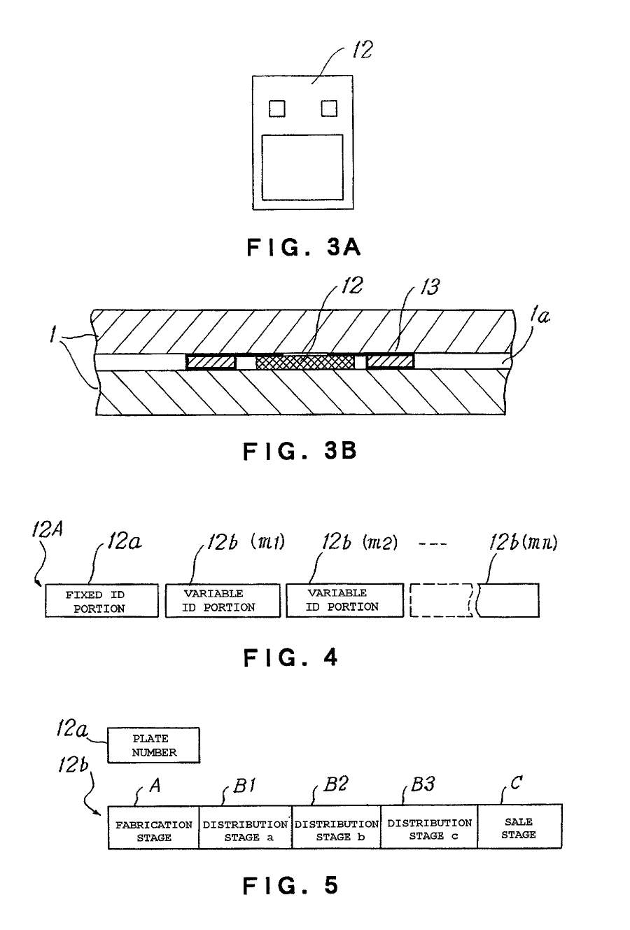

FIGS. 2A and 2B show an example of a structure of the noncontact ID tag, a recess portion in a circular shape is provided at a central portion of a resin holder 11 in a shape of a circular disk, at a bottom portion of inside of the recess portion, there are arranged an IC chip 12 built with an electronic element and an antenna coil 13, and upper portions thereof are covered by a resin mold 14 to constitute a plane face. Whereas the thickness of a wafer is normally about 300 through 500 μm, the thickness of the noncontact ID tag 10 is about 100 through 120 μm and is embedded into the inner layer portion of the printed circuit as described above, for example, in a step of connecting layers of the printed circuits perforated with through holes penetrating conductor patterns. Further, in this case, the IC chip 12 is formed in a rectangular shape and the antenna coil 13 in a circular shape is arranged at an outer periphery of the IC chip 12, however, shapes and arrangements of the IC chip 12 and the antenna coil 13 can be changed pertinently. Further, there may be constituted a mode in which there is not constructed the constitution integrally formed with the IC chip and the antenna but, as shown by FIG. 3A, there is constructed a constitution of a single member of the IC chip 12, as shown by FIG. 3B, the antenna 13 is attached to the side of the printed circuit 1 by, for example, printing a conductive ink in a required shape, in a step of connecting layers of the printed circuits, the IC chip 12 and the antenna 13 are connected and embedded in the adhesive layer la or may be constituted a mode in which the IC chip 12 and the antenna 13 are embedded in a recess portion formed at the printed circuit 1.

FIG. 4 shows, by a schematic diagram, a constitution of a storage for ID information of the noncontact ID tag and a memory 12A for ID information constituting one of characterizing points of the invention, comprises a fixed ID portion 12a comprising ROM stored with, at least, an ID code specifying the circuit and a variable ID portion 12b comprising RAM capable of changing the ID code by instruction from outside. The variable ID portion 12b is constituted by a plurality of memory cells (for example, constitution arranged with an non-volatile memory having 24 bits of a fixed length as one memory cell) and the respective memory cell is constructed by a memory cell array structure in which a memory cell array 12b (ml) through 12b(mn), is arranged in one row as shown by the drawing or in a matrix.

FIG. 5 shows an example of ID information stored to the memory 12A for ID information, at the fixed ID portion 12a exclusive for reading, at least an ID code (plate number) specifying the printed circuit is stored in, for example, fabrication stage. At respective memory cells of the variable ID portion 12b, at fabrication stage, distribution stage, and sale stage, by instruction from outside, there are recorded ID codes for respective kinds of business specifying the kinds of business at least dealing with the printed circuit, for example, ID codes indicating a route (maker, distributor, dealer of fabrication/distribution/sale, year and month or the like) of by which delivery route and by which store the printed circuit is made on sale or identifying kind or fabrication source of an electronic part such as a semiconductor chip mounted on the printed circuit.

According to the example of FIG. 5, there is constituted a system of adding an recording the ID codes for respective kinds of business at the memory cells (A, B1 through B3, C) of the variable ID portion 12b in accordance with a fabrication route, a delivery route, and a sale route. By writing and recording predetermined ID codes at least for respective kinds of business at the variable ID portion 12b from outside, based on data of the respective ID codes, there can be recognized the printed circuit and the kind of the mounted electronic part, the fabrication source, the distribution route and the like from an outside computer (personal computer or the like). Further, the maker, the distributor, and the dealer can control the printed circuit and the mounted electronic part and the product by the ID.

The ID codes of the variable ID portion are read/written by an exclusive software using a predetermined protocol and can be read/written even in high-speed transmission using radio wave having high frequency. Further, the ID information stored to the fixed ID portion and variable ID portion is not limited to that in the above-described example, further, a mode of recording a plurality of identifying information and added information in the above-described single ID code, is also included in the invention.

Although according to the above-described embodiment, an explanation has been given of, as an example, a case of embedding the noncontact ID tag in the adhesive layer between the printed circuits, the mode of embedding the noncontact ID tag is not limited thereto but a mode of embedding the noncontact ID tag in a recess or a hole formed in the printed circuit is also included in the invention.

As has been explained above, according to the invention, there is constructed the constitution of embedding the noncontact ID tag having the fixed ID portion and the variable ID portion capable of changing the ID codes from outside instruction, at the inner layer portion of the printed circuit and ID codes can be recorded at the fabrication stage, the distribution stage, and the sale stage and accordingly, secrecy of ID codes attached to the print circuit can be maintained, further, the route after distribution can be recognized from data of the ID codes of the printed circuit and there can be generally controlled the history of the printed circuit and the mounted electronic part including the distribution route after fabrication. Further, a problem with regard to copyright or patent right of a forged article or the like can be dealt with.

What is claimed is:

1. A printed circuit with an ID tag, wherein a noncontact ID tag having a fixed ID portion exclusive for reading storing an ID code at least specifying the printed circuit and a variable ID portion comprising a plurality of memory cells capable of changing the ID code by an instruction from outside, is embedded to an inner layer portion of the printed circuit.

2. The printed circuit with an ID tag according to claim 1, wherein a chip f or ID of the noncontact ID tag comprises a transponder element.

3. The printed circuit with an ID tag according to claim 1, wherein the respective memory cells of the variable ID portion are arranged in one row or in a matrix and recorded with ID codes at least indicating a route of distribution of the printed circuit by the instruction from the outside.

4. The printed circuit with an ID tag according to claim 1, wherein the ID code recorded in the variable ID portion includes identifying information for specifying a kind of business dealing with the printed circuit.

5. The printed circuit with an ID tag according to CLAIM 1, wherein the ID code recorded in the variable ID portion includes identifying information of a kind and a fabrication source of an electronic part mounted to the printed circuit.

6. A method of recognizing a distribution route, said method comprising the steps of:
embedding a tag for noncontact ID having a fixed ID portion exclusive for reading storing an ID code specifying at least the printed circuit and a variable ID portion comprising a plurality of memory cells capable of changing the ID code by an instruction from outside, at an inner layer portion of the printed circuit in a stage of fabricating the printed circuit;
writing the ID code specifying at least the printed circuit at the fixed ID portion;
recording the ID code indicating a route of distribution at the variable ID portion by the instruction from the outside at least at a delivery stage thereof; and recognizing the route of the distribution of the printed circuit based on data of the respective ID codes of the fixed ID portion and the variable ID portion.
